(19) United States
(12) Patent Application Publication
(10) Pub. No.: US 2024/0037904 A1
(43) Pub. Date: Feb. 1, 2024

(54) METHOD AND SYSTEM FOR PROVIDING INFORMATION ABOUT ARTIST TO USER BY USING MURALS

(71) Applicants: Jung Kyu PARK, Daegu (KR); RP INC., Daegu (KR)

(72) Inventor: Jung Kyu PARK, Daegu (KR)

(73) Assignees: Jung Kyu PARK, Daegu (KR); RP INC., Daegu (KR)

(21) Appl. No.: 18/013,511

(22) PCT Filed: Apr. 19, 2021
(86) PCT No.: PCT/KR2021/004865

§ 371 Date: Dec. 28, 2022

(30) Foreign Application Priority Data
Jun. 29, 2020 (KR) 10-2020-0078989
Jun. 29, 2020 (KR) 10-2020-0078990

(51) Int. Cl. G06V 10/74

(52) U.S. Cl. CPC G06V 10/761

(57) ABSTRACT

A method for providing information about an artist to a user by using murals, according to one embodiment of the present invention, comprises: an artist registration step in which a server obtains predetermined artist information, including murals, from an electronic device of an artist so as to register artist information about the artist; and a user use step in which the server obtains predetermined request information, including murals, from an electronic device of a user and provides, to the electronic device of the user, artist information about an artist, from among the registered plurality of artists, that satisfies predetermined matching conditions on the basis of the request information, wherein the predetermined matching conditions can be conditions satisfying a preset similarity or higher by comparing the murals included in the request information with the murals included in the information about the registered plurality of artists.

### TECHNICAL FIELD

The present invention relates to a method and system for providing information about an artist to a user using a mural, and more particularly, to a method and system for providing information about an artist who has painted a mural to a user using an image made by photographing the mural.

### BACKGROUND ART

Miami's Wynwood area was a typical slum area where black immigrants lived before the mural street was built.

This area was a typical place where the quality of life of residents was low as there were few leisure facilities such as national parks, swimming pools, libraries, and the like until 1990 due to the neglect of maintenance by government agencies.

In the early 2000s, artists bought or leased abandoned warehouses cheaply and started to use the abandoned warehouses as workshops, galleries, studios, or the like. After developer Tony Goldman made a mural street using six buildings in 2009, the mural street became a famous place called the “holy place of murals.”

Currently, about 50 artists representing 16 countries around the world are active, and it is estimated that about 1,000 murals have been painted.

However, currently, users (tourists) can only appreciate murals painted by artists, but there is a problem in that it is not easy to obtain information for purchasing other works of art by the corresponding artists or other works of art. Meanwhile, in Korean Laid-open Patent Application No. 10-2017-0058064 (published on May 26, 2017), a transaction system through pricing for works of art and a method thereof are disclosed.

However, there is a limit in that users can view murals on the site but cannot obtain other works of art by the corresponding artists and information about the artists.

Meanwhile, as the number of users who visit famous art museums or exhibition halls increases, interest in exhibited works of art is increasing.

Because the interest of users leads to a movement to purchase paintings or sculptures by famous painters or sculptors, some users may become customers who purchase artwork.

A general category of customers make contact with an artist or gallery separately to ascertain the value of a piece of artwork in order to place the artwork in their home or office.

In this case, a price of the artwork often varies from hundreds of thousands of won (KRW) to hundreds of millions of won (KRW), depending on the artist's fame, rarity and practicality of the artwork, time required to complete the artwork, and the like.

Meanwhile, unlike the case in which a purchase channel for other products is used, the process of finding a famous artist, finding the gallery of the artist, or the like in order to purchase artwork, is often closed, and thus there is a problem that customers are uncomfortable or profits are not fully delivered to the artist of the artwork.

In order to solve the above problem, in Korean Laid-open Patent Application No. 10-2020-0060068 (published on May 29, 2020), an online artwork transaction method and system are disclosed.

However, the above online artwork transaction method and system has a limitation that only a trading channel between a user and an artist is formed.

### DISCLOSURE

### Technical Problem

The present invention is directed to providing a method of providing information about an artist to a user using a mural, in which information about the artist who painted the mural can be easily obtained using the mural and information about a work of art available for purchase can also be obtained.

Objects of the present invention are not limited to the above-described object and other objects that are not described may be clearly understood by those skilled in the art from this specification and the accompanying drawings.

### Technical Solution

One aspect of the present invention provides a method of providing information about an artist to a user using a mural, including an artist registration step in which a server obtains artist information including a mural of a predetermined format from an electronic device of an artist to register the artist information about the artist; and a user use step in which the server obtains request information including a mural of a predetermined format from an electronic device of a user and provides, to the electronic device of the user, artist information about an artist, from among a plurality of registered artists, that satisfies a predetermined matching condition on the basis of the request information, wherein the predetermined matching condition is a condition in which a similarity obtained by comparing an image of the mural included in the request information with an image of each mural included in the artist information about the plurality of registered artists satisfies a preset similarity or higher.

### Advantageous Effects

According to a method of providing information about an artist to a user using a mural according to an embodiment of the present invention, information about an artist who painted a mural can be easily obtained using the mural and information about a work of art available for purchase can also be obtained.

Effects of the present invention are not limited to the above-described effect, and the other effects that are not described will be clearly understood by those skilled in the art from this specification and the accompanying drawings.

### DESCRIPTION OF DRAWINGS

FIG. 1 is a schematic diagram of components for implementing a method of providing information about an artist to a user using a mural according to a first embodiment of the present invention.

FIG. 2 is a schematic flowchart of the method of providing the information about the artist to the user using the mural according to the first embodiment of the present invention.

FIG. 3 is a schematic flowchart of a mural registration step in the method of providing the information about the artist to the user using the mural according to the first embodiment of the present invention.

FIG. 4 shows schematic views for describing images of murals that are obtained by an electronic device of an artist and/or an electronic device of a user.

FIG. 5 shows schematic views for describing a user use step in the method of providing the information about the artist to the user using the mural according to the first embodiment of the present invention.

FIG. 6 is a schematic configuration diagram of a system for providing information about an artist to a user using a mural according to the first embodiment of the present invention.

FIG. 7 is a schematic flowchart of an artwork transaction method using augmented reality according to a second embodiment of the present invention.

FIG. 8 is a schematic view for describing spatial information of the artwork transaction method using the augmented reality according to the second embodiment of the present invention.

FIG. 9 is a schematic view for describing artwork information of the artwork transaction method using the augmented reality according to the second embodiment of the present invention.

FIGS. 10 and 11 are schematic views for describing the provision of the artwork information of the artwork transaction method using the augmented reality according to the second embodiment of the present invention.

FIG. 12 is a schematic time table for describing desired purchase period information of the artwork transaction method using the augmented reality according to the second embodiment of the present invention.

### MODES OF THE INVENTION

Hereinafter, specific embodiments of the present invention will be described in detail with reference to the accompanying drawings. However, the spirit of the present invention is not limited to the embodiments presented in this specification. Those skilled in the art who understand the spirit of the present invention may easily suggest other embodiments that fall within the scope of the present invention or other regressive inventions by adding, changing, or removing other elements within the scope of the same concept, and the other embodiments are also within the spirit of the present invention.

A method of providing information about an artist to a user using a mural according to a first embodiment of the present invention may include an artist registration step in which a server obtains artist information including a mural of a predetermined format from an electronic device of an artist to register the artist information about the artist, and a user use step in which the server obtains request information including a mural of a predetermined format from an electronic device of a user and provides, to the electronic device of the user, artist information about an artist, from among a plurality of registered artists, that satisfies a predetermined matching condition on the basis of the request information, wherein the predetermined matching condition is a condition in which a similarity obtained by comparing an image of the mural included in the request information with an image of each mural included in the artist information about the plurality of registered artists satisfies a preset similarity or higher.

Further, in the artist registration step, the server may further obtain artist location information from the electronic device of the artist, in the user use step, the server may further obtain user location information from the electronic device of the user, and the predetermined matching condition is a condition in which a similarity obtained by comparing an image of the mural included in the request information and the user location information with an image of each mural included in the artist information about the plurality of registered artists and the artist location information satisfies a preset similarity or higher.

Further, the predetermined matching condition may be a condition in which the artist information about the plurality of registered artists, in which a similarity between the user location information and the artist location information satisfies a preset similarity or higher, is primarily extracted and a similarity obtained by secondarily comparing an image of the mural included in the extracted artist information about the plurality of artists with an image of the mural included in the request information satisfies a preset similarity or higher.

Further, the artist registration step may include a mural registration step in which the server obtains the mural from the electronic device of the artist to register the mural as a marker, an artist information acquisition step in which the server obtains the artist information including contact information and artwork information of the artist from the electronic device of the artist, and an artist information storage step in which the server matches and stores the artist information with the mural.

Further, in the mural registration step, the server may obtain the mural photographed at several angles and the artist location information from the electronic device of the artist to primarily generate an experimental marker, the server may reobtain the mural photographed at several angles from the electronic device of the artist to secondarily determine whether the experimental marker functions properly, and when it is determined that the experimental marker functions properly, the server may register the experimental marker as the marker.

Further, in the mural registration step, when the server obtains the mural photographed at several angles from the electronic device of the artist, the server may determine whether a similarity between an image of the photographed mural and an image of a mural of another registered artist is greater than or equal to a preset similarity.

Further, in the user use step, the server may obtain user information including the user location information and the user's age or age group from the electronic device of the user and store the user information.

A system for providing the information about the artist to the user using the mural according to the first embodiment of the present invention, which obtains artist information including a mural of a predetermined format from an electronic device of an artist to register the artist information about the artist, and obtains request information including a mural of a predetermined format from an electronic device of a user and provide, to the electronic device of the user, artist information about an artist, from among a plurality of registered artists, that satisfies a predetermined matching condition on the basis of the request information, wherein the predetermined matching condition may be a condition in which a similarity obtained by comparing an image of the mural included in the request information with an image of each mural included in the artist information about the plurality of registered artists satisfies a preset similarity or higher.

Further, the system may further obtain artist location information from the electronic device of the artist, and may further obtain user location information from the electronic device of the user, wherein the predetermined matching condition may be a condition in which a similarity obtained by comparing an image of the mural included in the request information and the user location information with an image of each mural included in the artist information about the plurality of registered artists and the artist location information satisfies a preset similarity or higher.

Further, the predetermined matching condition may be a condition in which the artist information about the plurality of registered artists, in which a similarity between the user location information and the artist location information satisfies a preset similarity or higher, is primarily extracted and a similarity obtained by secondarily comparing an image of the mural included in the extracted artist information about the plurality of artists with an image of the mural included in the request information satisfies a preset similarity or higher.

Further, the system may obtain the mural from the electronic device of the artist to register the mural as a marker, obtain the artist information including contact information and artwork information of the artist from the electronic device of the artist, and match and store the artist information with the mural.

Further, the system may obtain the mural photographed at several angles and the artist location information from the electronic device of the artist to primarily generate an experimental marker, reobtain the mural photographed at several angles from the electronic device of the artist to secondarily determine whether the experimental marker functions properly, and when it is determined that the experimental marker functions properly, register the experimental marker as the marker.

Further, when the system obtains the mural photographed at several angles from the electronic device of the artist, the system may determine whether a similarity between an image of the photographed mural and an image of a mural of another registered artist is greater than or equal to a preset similarity.

Further, the system may obtain user information including the user location information and the user's age or age group from the electronic device of the user and store the user information.

An artwork transaction method using augmented reality according to a second embodiment of the present invention may include a consumer information acquisition step in which a server obtains consumer information including spatial information, which is information about a space in which an artwork is to be placed, a desired purchase price of the artwork, and a type of the artwork to be purchased from an electronic device of a consumer, a consumer information provision step in which the server provides the consumer information to an electronic device of an artist, an artwork information acquisition step in which the server obtains artwork information including an artwork image, which is an image of the artwork, and a desired selling price from the electronic device of the artist, an alarm provision step in which, when the server obtains the artwork information, the server provides an alarm indicating that the artwork information is obtained to the electronic device of the consumer, a request information acquisition step in which the server obtains request information for requesting the artwork information from the electronic device of the consumer, and an artwork information provision step in which the server provides the artwork information to the electronic device of the consumer, wherein, in the artwork information provision step, augmented reality information about the artwork may be provided so that the artwork image is displayed in augmented reality in the space in which the artwork is to be placed on the electronic device of the consumer.

Further, the consumer information may further include information about a desired location of the artwork, which is a desired location at which the artwork is to be placed.

Further, the artwork information may further include artwork suggestion location information for suggesting a location at which the artist will place the artwork, and in the artwork information provision step, the augmented reality information may be provided at a location corresponding to the artwork suggestion location information.

Further, the consumer information may further include desired purchase period information, which is a desired purchase date of the artwork, and in the artwork information acquisition step, the artwork information may be obtained from the electronic device of the artist only up to the desired purchase date on the basis of the desired purchase period information.

Further, the artwork information may further include number information about the number of identical pieces of artwork.

Further, the number information may further include information about the number of sales of the same artwork and the number of pieces of artwork owned by the artist.

Further, in the artwork information provision step, history information about a history of providing the artwork information for the same artwork may be further provided to an electronic device of another consumer.

Further, the artwork transaction method may further include a similarity calculation step in which, when the server obtains the artwork image in the artwork information acquisition step, the server calculates a similarity by comparing the artwork image with a pre-obtained image of another piece of artwork, wherein, in the artwork information provision step, the artwork information having a similarity greater than or equal to a preset similarity that is calculated in the similarity calculation step may also be provided to the electronic device of the consumer.

An artwork transaction system using augmented reality according to the second embodiment of the present invention may obtain consumer information including spatial information, which is information about a space in which a piece of artwork is to be placed, a desired purchase price of the artwork, and a type of the artwork to be purchased from an electronic device of a consumer, provide the consumer information to an electronic device of an artist, obtain artwork information including an artwork image, which is an image of the artwork, and a desired selling price from the electronic device of the artist, when the artwork information is obtained from the electronic device of the artist, provide an alarm indicating that the artwork information is obtained to the electronic device of the consumer, obtain request information for requesting the artwork information from the electronic device of the consumer, and provide the artwork information to the electronic device of the consumer, wherein, when the artwork information is provided to the electronic device of the consumer, augmented reality information about the artwork may be provided so that the artwork image is displayed in augmented reality in the space in which the artwork is to be placed on the electronic device of the consumer.

Further, the consumer information may further include information about a desired location of the artwork, which is a desired location at which the artwork is to be placed.

Further, the artwork information may further include artwork suggestion location information for suggesting a location at which the artist will place the artwork, and when the artwork information is provided to the electronic device of the consumer, the augmented reality information may be provided at a location corresponding to the artwork suggestion location information.

Further, the consumer information may further include desired purchase period information, which is a desired purchase date of the artwork, and when the artwork information is obtained from the electronic device of the artist, the artwork information may be obtained from the electronic device of the artist only up to the desired purchase date on the basis of the desired purchase period information.

Further, the artwork information may further include number information about the number of identical pieces of artwork.

Further, the number information may further include information about the number of sales of the same artwork and the number of pieces of artwork owned by the artist.

Further, when the artwork information is provided to the electronic device of the consumer, history information about a history of providing the artwork information for the same piece of artwork may be further provided to an electronic device of another consumer.

Further, when the artwork image is obtained, a similarity may be calculated by comparing the artwork image with a pre-obtained image of another piece of artwork, and when the artwork information is provided to the electronic device of the consumer, the artwork information about another piece of artwork having a similarity greater than or equal to a preset similarity may also be provided to the electronic device of the consumer.

Elements having the same functions within the spirit of the same idea illustrated in the drawings of the embodiments will be described using the same reference numerals.

In the accompanying drawings, in order to more clearly express the technical spirit of the preset invention, portions that are not related to the technical spirit of the preset invention or that can be easily derived by those skilled in the art will be simplified or omitted.

The present invention relates to a method and system for providing artwork information, and the method and system may be a method and system for providing information about a piece of artwork to a consumer (user).

Hereinafter, two embodiments of the method and system for providing the artwork information of the present invention will be separately described.

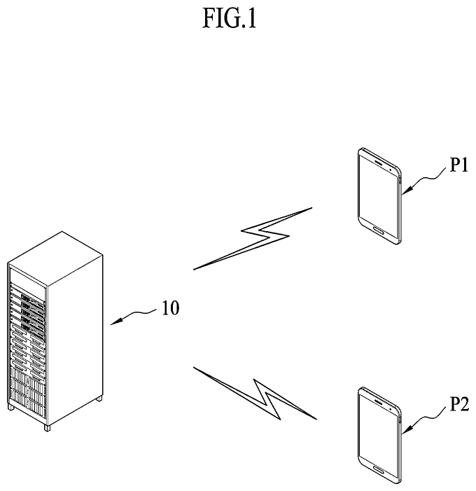

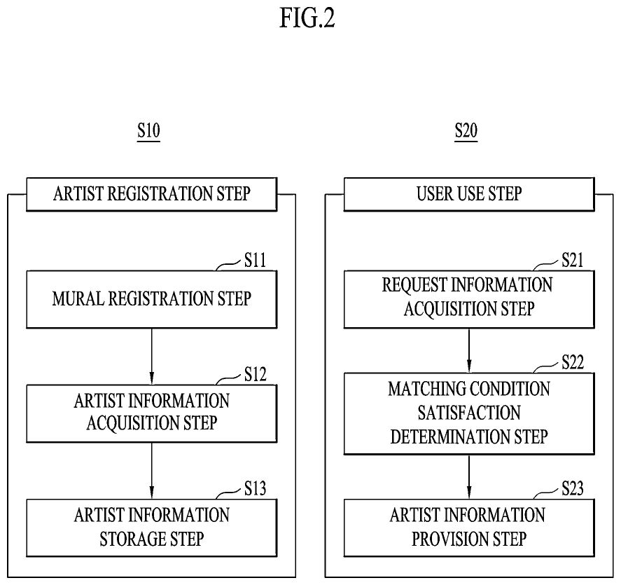

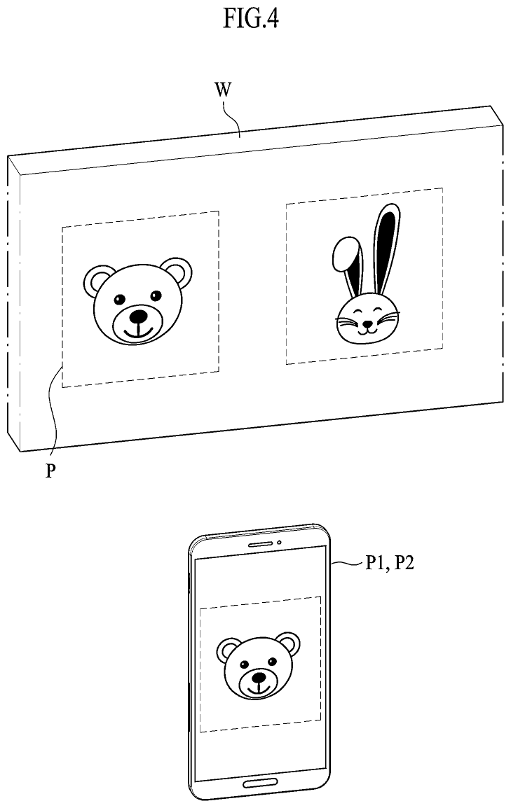

First, a method and system for providing artwork information according to a first embodiment will be described with reference to FIGS. 1 to 6.

The method and system for providing the artwork information according to the first embodiment may be referred to as a method and system for providing information about an artist to a user using a mural.

As shown in FIGS. 1 to 6, in the method of providing the information about the artist to the user using the mural according to the first embodiment of the present invention, an artist may directly register the artist's own artist information in a server 10 through a mural, which is a type of artwork, as a medium, and a user may obtain the artist information of the corresponding artist from the server 10 through the mural as the medium.

The server 10 may transmit or receive information/data of a predetermined format to or from an electronic device P1 of the artist and an electronic device P2 of the user.

Each of the electronic device P1 of the artist and the electronic device P2 of the user may be a portable electronic device such as a smartphone, a tablet personal computer (PC), or the like, may photograph a mural, and may include a Global Positioning System (GPS) device or the like to generate location information.

As an example, the method of providing the information about the artist to the user using the mural may include an artist registration step S10 in which the server 10 obtains artist information including a mural of a predetermined format from the electronic device P1 of the artist to register the artist information about the artist, and a user use step S20 in which the server 10 obtains request information including a mural of a predetermined format from the electronic device P2 of the user and provides, to the electronic device P2 of the user, artist information about the artist, from among a plurality of registered artists, that satisfies a predetermined matching condition on the basis of the request information.

That is, the method of providing the information about the artist to the user using the mural may be largely divided into the artist registration step S10 in which the artist registers his/her own artist information in the server 10 together with murals the artist has made, and the user use step S20 in which the user obtains the artist information about the artist matching a photographed mural from the server 10.

Hereinafter, the artist registration step S10 and the user use step S20 will be separately described in detail.

—Artist Registration Step S10—

Hereinafter, the artist registration step S10 will be described in detail with reference to FIGS. 1 to 4.

The artist registration step S10 may be a step in which the artist who paints the mural registers the artist's artist information in the server 10 through the mural as a medium.

As an example, the artist registration step S10 may include a mural registration step S1) in which the server 10 obtains the mural (image obtained by photographing the mural) from the electronic device P1 of the artist to register the mural as a marker.

As an example, the artist may paint a mural P on a wall W of a structure, and after the mural is completed, the artist may photograph the mural through an electronic device, that is, the electronic device P1 of the artist, and transmit the image of the mural to the server 10.

In this case, the server 10 may display an artist-only connection icon and a user-only connection icon on a main screen accessed by the electronic device P1 of the artist and the electronic device P2 of the user, and the artist may touch the artist-only connection icon to proceed with the artist registration step S10.

When the server 10 obtains the mural from the electronic device P1 of the artist, the server 10 may register the mural as the marker.

Here, as an example, the artist registration step S10 may further include an artist information acquisition step S12 in which the server 10 obtains the artist information including contact information and artwork information of the artist from the electronic device P1 of the artist.

The artist may input the artist's name, sex, introduction, e-mail address, and/or contact information through the artist's electronic device P1 to transmit the input name, sex, introduction, e-mail address, and/or contact information to the server 10, and may further input the artwork information about an image, video, and/or price of artist's another artwork (e.g., a mural, a painting, a sculpture, etc. painting in another location) to transmit the input artwork information about the image, video, and/or price of the artist's other artwork to the server 10.

Further, the artist may input an address (website address or social networking service (SNS) address) of another server 10 indicating the artist information to transmit the input address to the server 10.

Therefore, the server 10 may obtain the artist information from the electronic device P1 of the artist.

Here, as an example, the artist registration step S10 may further include an artist information storage step S13 in which the server 10 matches and stores the artist information with the mural.

When the server 10 obtains the artist information, the server 10 may match and store the mural of the artist registered as the marker with the artist information.

The server 10 may match and store the mural of the artist and the artist information of the corresponding artist in the artist registration step S10 from each of a plurality of artists.

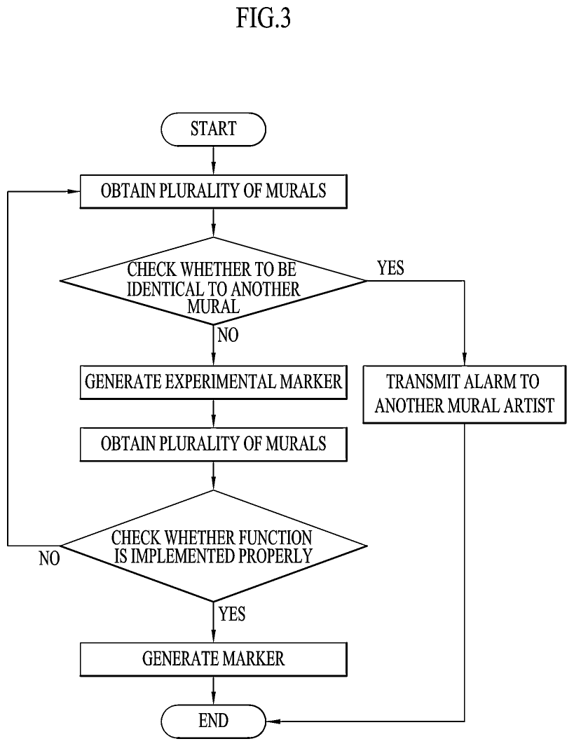

Hereinafter, the mural registration step S11 will be described in more detail with reference to FIG. 3.

In the mural registration step S11, the server 10 obtains mural photographed at several angles and artist location information, which is a location of the mural, from the electronic device P1 of the artist to primarily generate an experimental marker.

More specifically, the server 10 may request images of the mural photographed at several angles from the electronic device P1 of the artist in order to generate the experimental marker.

The artist may transmit the plurality of mural images, which are generated by photographing the mural painted by the artist at several angles through the artist's electronic device P1, to the server 10.

Further, the artist may transmit the artist location information, which is location information about the plurality of mural images to the server 10 through the artist's electronic device P1.

The artist location information may be location information about a location of the electronic device P1 of the artist, which is generated when the electronic device P1 of the artist photographs the mural.

The electronic device P1 of the artist may transmit the artist location information obtained through a mounted GPS device or the like as well as the mural images obtained by photographing the mural to the server 10.

In this case, the server 10 may check whether a plurality of murals obtained from the electronic device P1 of the artist are the same as other murals of other registered artists.

When it is checked that each of the plurality of murals obtained from the electronic device P1 of the artist is the same as each of other murals of other registered artists, the corresponding mural may not only cause copyright problems, but may not be able to implement the function as a marker.

The server 10 may determine whether a similarity obtained by comparing an image of each of the plurality of murals obtained from the electronic device P1 of the artist with an image of each of other murals of other registered artists satisfies a preset similarity or higher. When it is determined that the similarity satisfies the preset similarity or higher, the server 10 may determine that each of the plurality of murals obtained from the electronic device P1 of the artist is the same as other murals of other registered artists, and when it is not determined that the similarity satisfies the preset similarity or higher, the server 10 may determine that each of the plurality of murals obtained from the electronic device P1 of the artist is not the same as other murals of other registered artists.

Since there are many known techniques for determining a similarity between an image and another image, a detailed description thereof will be omitted.

Meanwhile, the server 10 may prioritize the artist location information about the plurality of murals obtained from the electronic device P1 of the artist, select other murals located within a predetermined distance from the location of the mural derived from the artist location information as a population, and determine a similarity with other murals in the population.

More specifically, as an example, in the mural registration step S11, the server 10 may use the artist location information about the plurality of murals obtained from the electronic device P1 of the artist as a central point, preferentially select other murals within 10 Km (relatively greater than a distance in the matching condition satisfaction determination step S22, which will be described below) from the central point as the population, and determine a similarity between an image of other murals included in the population and an image of each of the plurality of murals obtained from the electronic device P1 of the artist.

Here, when the server 10 determines that each of the plurality of murals obtained from the electronic device P1 of the artist is the same as other murals of other registered artists (when the similarity satisfies the preset similarity or higher), the server 10 may transmit an alarm together with the plurality of murals obtained from the electronic device P1 of the artist to the artist of the corresponding mural.

The artist of other murals may see the plurality of murals transmitted by the server 10, check whether the plurality of murals actually conflict with the copyright for the artist's own murals, and transmit the artist's opinion to the server 10.

Meanwhile, when the server 10 determines that each of the plurality of murals obtained from the electronic device P1 of the artist is not the same as other murals of other registered artists, the server 10 may generate the plurality of murals obtained from the electronic device P1 of the artist as the experimental marker.

Here, as an example, in the mural registration step S11, the server 10 reobtains the mural photographed from several angles from the electronic device P1 of the artist to secondarily determine whether the experimental marker functions properly.

More specifically, when the experimental marker is generated, the server 10 may re-request images obtained by photographing the mural at several angles from the electronic device P1 of the artist, and the artist may re-photograph his/her mural at several angles through the artist's electronic device to transmit images obtained by photographing the mural to the server 10.

When the server 10 reobtains a plurality of murals from the electronic device P1 of the artist, the server 10 may determine whether the generated experimental marker functions properly as a marker for each of the plurality of reobtained murals, and when it is determined that the experimental marker functions properly as the marker, the server 10 may register/generate the experimental marker as the marker.

When it is not determined that the experimental marker functions properly, a step of re-generating the experimental marker may be implemented.

As described above, it is obvious that the preceding and proceeding step of each step may be changed as long as the technical scope of the present invention is implemented.

As an example, after the artist information acquisition step S12 is first implemented, the mural registration step S11 may be implemented to implement the technical scope of the present invention.

—User Use Step S20—

Hereinafter, the user use step S20 will be described in detail with reference to FIGS. 1, 2, 4, and 5.

The user use step S20 may include a request information acquisition step S21 in which the server 10 obtains the request information including the mural from the electronic device P2 of the user, a matching condition satisfaction determination step S22 in which the server 10 determines whether the predetermined matching condition is satisfied based on the obtained request information, and an artist information provision step S23 in which, when it is determined that the predetermined matching condition is satisfied, the server 10 transmits the artist information about the corresponding artist to the electronic device P2 of the user.

As an example, the user use step S20 may be a step in which the mural of the artist registered in the artist registration step S10 is used as a marker and when the user photographs the mural through the user's electronic device P2 to transmit the mural to the server 10, the artist information about the artist who worked on the transmitted mural is obtained from the server 10.

As an example, in the user use step S20, the server 10 may obtain the mural from the electronic device P2 of the user, determine whether the obtained mural corresponds to the registered marker, and when it is determined that the obtained mural corresponds to the registered marker, transmit the artist information about the corresponding artist to the electronic device P2 of the user.

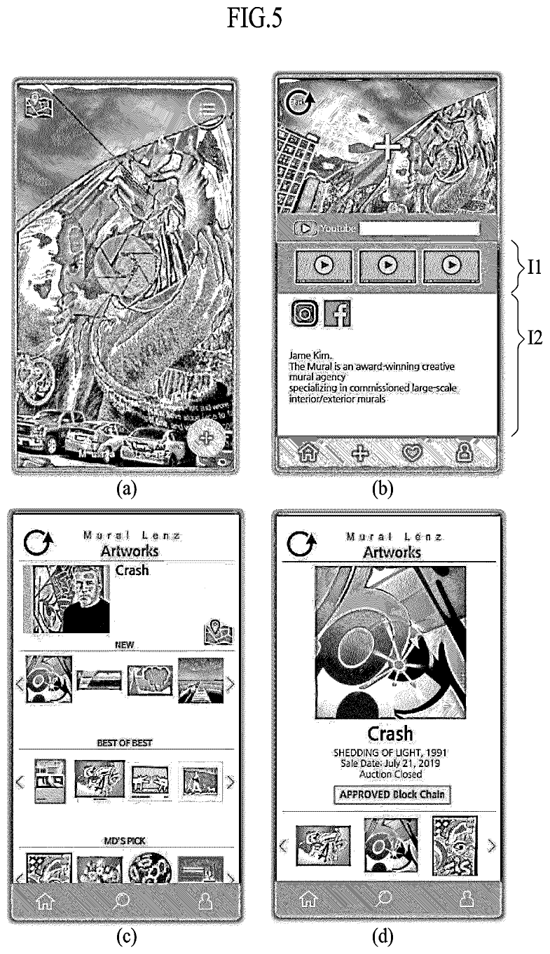

As an example, FIG. 5 shows examples of a screen displayed on the electronic device P2 of the user step by step, and as shown in FIG. 5A, the user may appreciate the mural P painted on the wall W of the structure, photograph the mural through the user's electronic device P2, that is, the electronic device P2 of the user, and transmit an image of the mural to the server 10.

Here, the electronic device P2 of the user may transmit not only the photographed mural but also the user location information to the server 10.

The user location information may be location information about a location at which the electronic device P2 of the user is located, which is generated when the electronic device P2 of the user photographs the mural.

The electronic device P2 of the user may transmit the user location information obtained through a mounted GPS device or the like as well as the mural images obtained by photographing the mural to the server 10.

In this case, the server 10 may display an artist-only connection icon and a user-only connection icon on a main screen accessed by the electronic device P1 of the artist and the electronic device P2 of the user, and the user may touch the user-only connection icon to proceed with the user use step S20.

When the server 10 obtains the mural (mural image) from the electronic device P2 of the user, the server 10 may determine whether a similarity obtained by comparing an image of the mural obtained from the user with an image of each of the plurality of markers (murals) registered in the artist registration step S10 satisfies a preset similarity or higher.

Here, when the server 10 obtains the mural and the user location information from the electronic device P2 of the user in the request information acquisition step S21, the server 10 may primarily compare the location information of the user with the artist location information included in the artist information about the plurality of registered artists to select only the marker (mural) of the artist that a similarity between images of the both satisfy the preset similarity or higher (the location of the user and the location of the mural of the artist located within the preset distance) as a population, and may secondarily compare the mural obtained from the electronic device P2 of the user with the marker (mural) included in the artist information about the plurality of registered artists within the population to determine whether a similarity between images of the both satisfy the preset similarity or higher.

More specifically, as an example, in the matching condition satisfaction determination step S22, the server 10 may use the user location information about the mural obtained from the electronic device P2 of the user as a central point, preferentially select the mural of the registered artist within 500 m (relatively smaller than a distance in the mural registration step S11 described above) from the central point as the population, and determine a similarity between an image of the mural of the artist included in the population and an image of the mural obtained from the electronic device P2 of the user.

In this case, when there is a mural (marker) whose similarity with the mural obtained from the electronic device P2 of the user is greater than or equal to the preset similarity among the murals of the artist included in the population, the server 10 may transmit the artist information about the corresponding mural to the electronic device P2 of the user.

FIG. 5B shows a screen in which the electronic device P2 of the user receives the artist information from the server 10, and as an example, the electronic device P2 of the user may display artist's personal information 12 including a name, introduction, SNS address, e-mail address, etc. of the artist pre-registered by the corresponding artist in the server 10 on a photographing screen, and further display artwork information I1 for a video introducing other artwork, a link to another website, and the like.

Here, when the user clicks on a link, the user may access the linked website and view other artworks of the corresponding artist, as shown in FIG. 5C.

Further, as shown in FIG. 5D, the server 10 may transmit price information about a price of the artwork of the corresponding artist to the electronic device P2 of the user.

When, among the murals of the artist included in the population, there is no mural (marker) whose similarity with the mural obtained from the electronic device P2 of the user is greater than or equal to the preset similarity, the server 10 may re-request photographing the mural at a different angle from the electronic device P2 of the user, and re-implement the matching condition satisfaction determination step S22 on the basis of the mural obtained by re-photographing.

Meanwhile, in the user use step S20, the server 10 may obtain the user information including the user location information and the user's age or age group from the electronic device P2 of the user and store the user information.

More specifically, the server 10 may obtain the user information including the user's age or age group in advance or when obtaining the mural from the electronic device P2 of the user, and may match and store the user location information obtained from the electronic device P2 of the user together with the user information.

Such data may be used as marketing utilization data such as commercial area analysis in the future.

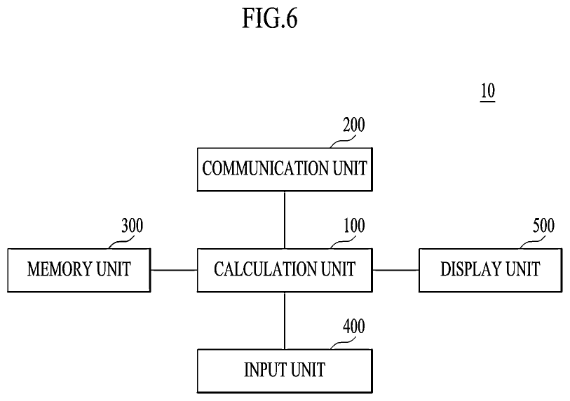

Hereinafter, a system for providing information about an artist to a user using a mural will be described with reference to FIG. 6.

As an example, the system for providing the information about the artist to the user using the mural may be a device for implementing the method of providing the information about the artist to the user using the mural described above.

As an example, the system for providing the information about the artist to the user using the mural may be the server 10 for implementing the method of providing the information about the artist to the user using the mural by transmitting or receiving information/data of a predetermined format to or from the electronic device P1 of the artist and the electronic device P2 of the user described above.

As an example, the system for providing the information about the artist to the user using the mural may include a communication unit 200 that transmits or receives the above-described information/data of the predetermined format required to implement the method of providing the information about the artist to the user using the mural to or from the electronic device P1 of the artist and the electronic device P2 of the user.

As an example, the system for providing the information about the artist to the user using the mural may include a calculation unit 100 that computes, calculates, and controls the above-described information/data of the predetermined format required to implement the method of providing the information about the artist to the user using the mural.

As an example, the system for providing the information about the artist to the user using the mural may include a memory unit 300 in which the above-described information/data of the predetermined format required to implement the method of providing the information about the artist to the user using the mural is stored.

As an example, the system for providing the information about the artist to the user using the mural may include an input unit 400 that receives the above-described information/data of the predetermined format required to implement the method of providing the information about the artist to the user using the mural from a manager.

As an example, the system for providing the information about the artist to the user using the mural may include a display unit 500 for displaying the above-described information/data of the predetermined format required to implement the method of providing the information about the artist to the user using the mural to the manager.

As an example, the communication unit 200 may obtain artist information including a mural of a predetermined format from an electronic device P1 of an artist, and the memory unit 300 may register/store the artist information about the artist.

The communication unit 200 may obtain request information including the mural of a predetermined format from an electronic device P2 of a user, and the calculation unit 100 may provide the artist information about the artist, from among a plurality of registered artists, that satisfies a predetermined matching condition on the basis of the request information to the electronic device P2 of the user through the communication unit 200.

The communication unit 200 may further obtain the artist location information from the electronic device P1 of the artist and further obtain the user location information from the electronic device P2 of the user, and the calculation unit 100 may implement the matching condition satisfaction determination step S22 on the basis of the predetermined matching condition.

The communication unit 200 may obtain the mural from the electronic device P1 of the artist, the calculation unit 100 may register the mural as a marker, the communication unit 200 may obtain the artist information including contact information and artwork information of the artist from the electronic device P1 of the artist, and the calculation unit 100 may match and store the artist information with the mural in the memory unit 300.

The communication unit 200 may obtain the mural photographed at several angles and the artist location information from the electronic device P1 of the artist, and the calculation unit 100 may primarily generate an experimental marker.

The communication unit 200 may obtain the mural re-photographed at several angles from the electronic device P1 of the artist, and the calculation unit 100 may secondarily determine whether the experimental marker functions properly.

Here, when it is determined that the experimental marker functions properly, the calculation unit 100 may register/store the experimental marker as a marker in the memory unit 300.

When the communication unit 200 obtains the mural photographed at several angles from the electronic device P1 of the artist, the calculation unit 100 may determine whether a similarity between an image of the photographed mural and an image of a mural of another registered artist is greater than or equal to a preset similarity.

The memory unit 300 may obtain the user information including the user location information and the user's age or age group from the electronic device P2 of the user and store the user information.

Hereinafter, a method and system for providing artwork information according to a second embodiment will be described with reference to FIGS. 1 and 6 to 12.

The method and system for providing the artwork information according to the second embodiment may be referred to as an artwork transaction method and system using augmented reality.

As shown in FIGS. 1 and 6 to 12, the artwork transaction method and system using the augmented reality according to the second embodiment of the present invention may be a method and system in which a server 10 transmits or receives information/data of a predetermined format to or from an electronic device P1 of a consumer and an electronic device P2 of an artist (shown in FIG. 1) and guides an artwork transaction between the consumer and the artist.

The server 10 may be a “system.”

The consumer may be a user who desires to purchase a piece of artwork, and the artist may be a user who desires to sell a piece of artwork.

The artwork is a work of art, and is not limited to a type thereof such as a painting, a sculpture, or the like.

However, for convenience of description, description will be made assuming a case in which the artwork is a painting.

Further, each of the electronic device P1 of the consumer and the electronic device P2 of the artist may be a portable terminal, a smartphone, a desktop computer, a portable computer, or the like, and may correspond to any device as long as it can transmit or receive information/data of a predetermined format to or from the server 10.

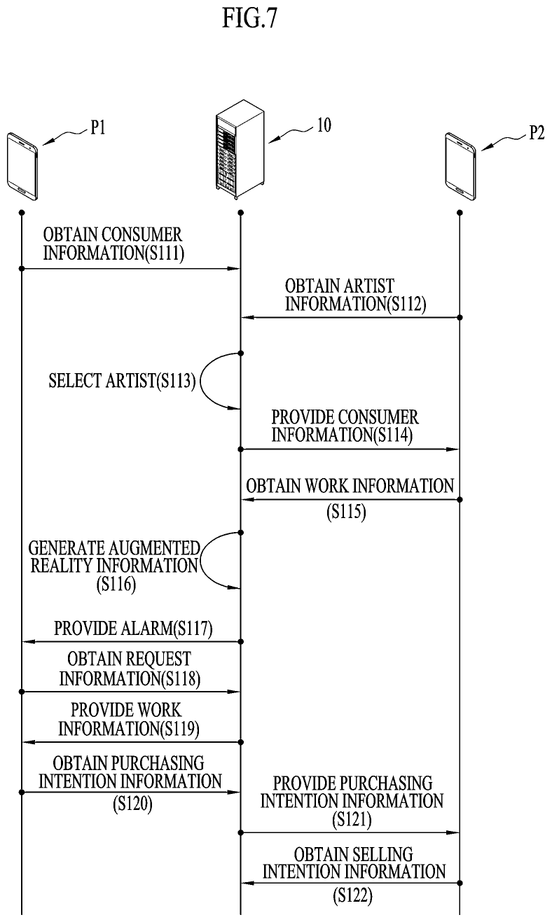

As shown in FIG. 7, as an example, the artwork transaction method using the augmented reality may include a consumer information acquisition step S111, an artist information acquisition step S112, an artist selection step S113, a consumer information provision step S114, an artwork information acquisition step S115, an augmented reality information generation step S116, an alarm provision step S117, a request information acquisition step S118, an artwork information provision step S119, a purchasing intention information acquisition step S120, a purchasing intention information provision step S121, and a selling intention information acquisition step S122.

The order of the steps described above is not limited to the order shown in FIG. 7, and for example, the artist information acquisition step S112 may take precedence over the consumer information acquisition step S111.

That is, when the artwork transaction method using the augmented reality, which will be described below, is implemented, it is obvious that the order of the steps may be changed.

Hereinafter, each step of the artwork transaction method using the augmented reality will be described in more detail.

The artwork transaction method using the augmented reality may include the consumer information acquisition step S111.

The consumer information acquisition step S111 may be a step of obtaining, by the server 10, consumer information including spatial information, which is information about a space in which a piece of artwork is to be placed, a desired purchase price of the artwork, and a type of the artwork to be purchased from the electronic device P1 of the consumer.

The spatial information may be an image and/or video obtained by photographing a space in which the consumer will place the artwork.

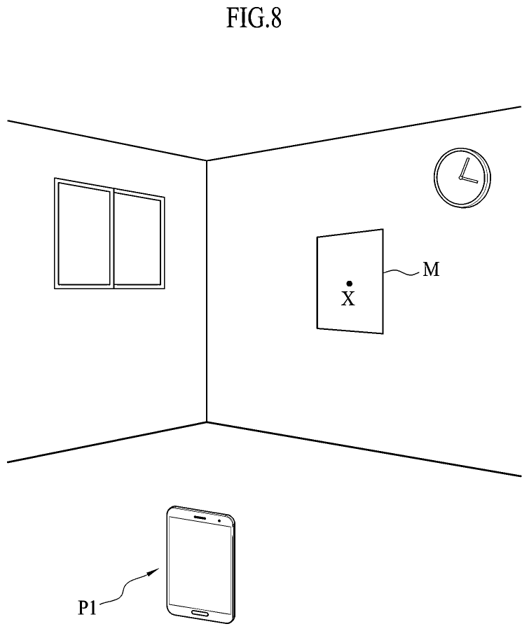

As an example, as shown in FIG. 8, the consumer may use the consumer's electronic device P1 to photograph the space in which the artwork is to be placed, and may transmit the photographed image and/or video to the server 10.

Further, the desired purchase price is a purchase price of the artwork desired by the consumer, and the consumer may designate a specific amount (e.g., $100 (USD)) or designate an amount in a specific range (e.g., $80 to $120) to transmit the designated amount to the server 10.

Further, the type of the artwork is a type of the artwork desired by the consumer, and for example, the consumer may select any one of paintings, sculptures, and the like, select any one of portraits and landscapes from among the paintings, and transmit a type of the selected one to the server 10.

Here, as an example, the consumer information may further include information about an address, name, sex, and age of the consumer, information about a size of the desired artwork, information about whether to buy or rent the artwork, information about a desired location of the artwork, which is a desired location at which the artwork is to be placed on the spatial information, and information about a purchase period, which is a desired purchase date of the artwork in addition to the spatial information, the desired purchase price, and the type of the artwork.

The consumer may designate a specific size (e.g., 100 cm in width×160 cm in height) for the size of the desired artwork or designate a size (e.g., 200 cm in width×260 cm or less in height) within a specific range and transmit the designated size to the server 10.

The consumer may designate the desired location at which the artwork is to be placed in the spatial information and transmit the information about the desired location of the artwork to the server 10.

As an example, as shown in FIG. 8, the information about the desired location of the artwork may be transmitted to the server 10 by photographing the space in which the artwork is to be placed after a predetermined marker M is installed on a wall on which the artwork is to be placed, or the information about the desired location of the artwork may be transmitted to the server 10 by photographing the space in which the artwork is to be placed after a predetermined point X is displayed on the wall on which the artwork is to be placed.

As an example, the server 10 may provide the predetermined marker M to the electronic device P1 of the consumer in the form of a file, and the consumer may output the marker M through the consumer's electronic device P1 and place the marker M in the space in which the artwork is to be placed.

Further, as an example, the consumer may designate the information about the purchase period (e.g., within one month from today), which is the desired purchase date of the artwork, and transmit the designate information about the purchase period to the server 10.

The server 10 may obtain the consumer information from the electronic device P1 of the consumer and store the consumer information in the consumer information acquisition step S111.

Here, as an example, the artwork transaction method using the augmented reality may further include the artist information acquisition step S112 of obtaining the artist information.

As an example, the artist information may include information about an address, name, sex, and age of the artist, information about a size of the artwork being sold, information about whether to sell or rent the artwork, information about a desired selling price of the artwork to be sold, information about a size of the artwork to be sold, information about a date available for sale, information about areas available for sale, information about a type of the artwork available for sale, and the like.

The server 10 may obtain the artist information from the electronic device P2 of the artist and store the artist information in the artist information acquisition step S112.

Here, as an example, the artwork transaction method using the augmented reality may further include the artist selection step S113 in which the server 10 matches the consumer information with the artist information and selects an artist who will provide the consumer information from among many pre-registered artists.

That is, in the artist selection step S113, when the server 10 obtains the consumer information, the server 10 does not provide the consumer information to the electronic devices P2 of all artists pre-stored in the server 10, and matches the artist information pre-stored in the server 10 with the consumer information to select the artists satisfying a preset matching condition.

As an example, the preset matching condition may be a condition in which only artists having a similarity greater than or equal to a preset similarity are selected by comparing each piece of information constituting the consumer information and each piece of information constituting the artist information.

For example, when the type of the artwork desired by the consumer included in the consumer information is a painting and the purchase price of the artwork desired by the consumer is $100, the server 10 may select an artist by filtering the artists having information that the type of artwork available for sale is a painting and $100 is included in a range of the desired selling price of the artwork to be sold, from among the pre-stored artist information.

Here, as an example, the artwork transaction method using the augmented reality may further include the consumer information provision step S114 in which the server 10 provides the consumer information to the electronic device P2 of the artist selected in the artist selection step S113.

Therefore, the artist may see the consumer information transmitted by the server 10 through the artist's electronic device P2 and determine whether to sell the artist's artwork to the corresponding consumer.

Here, as an example, the artwork transaction method using the augmented reality may further include the artwork information acquisition step S115 in which the server 10 obtains the artwork information including an artwork image, which is an image of the artwork, and a desired selling price from the electronic device P2 of the artist.

That is, the artist may transmit the artwork information to the server 10 through the artist's electronic device P2, and the server 10 may receive and store the artwork information.

As an example, the artwork information may include an image and/or video of the artwork captured by the artist through the artist's electronic device P2.

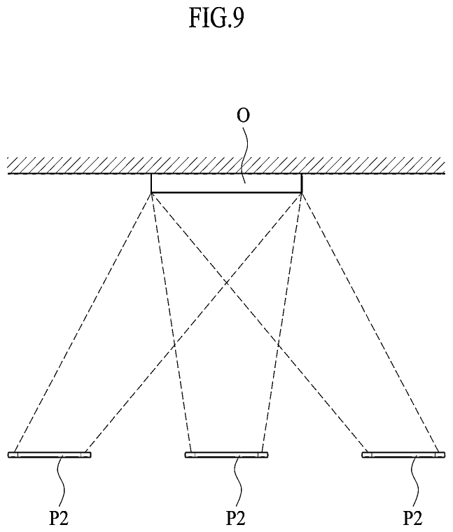

More specifically, as shown in FIG. 9, the artist may photograph a piece of artwork K to be sold at several angles and at several distances through the artist's electronic device P2, and may transmit the image and/or video of the artwork captured in this way to the server 10.

Further, as an example, the artwork information may include information about the desired selling price of the artwork for how much the artist will sell the corresponding artwork, and may further include information about the size of the corresponding artwork.

That is, the artist may input the desired sale price and the size of the artwork through the artist's electronic device P2 and transmit the input desired sale price and size of the artwork to the server 10.

Further, the artwork information may further include number information about the number of pieces of artwork identical to the corresponding artwork.

In this case, the number information may include information about the number of sales of the artwork identical to the corresponding artwork to other consumers, and information about the number of pieces of artwork that are currently owned by the artist.

That is, the artist may input the number information through the artist's electronic device P2 and transmit the input number information to the server 10.

Further, the artwork information may further include artwork suggestion location information for suggesting a location at which the artist will place the artwork.

The artist may see the spatial information and the information about the desired location of the artwork that are input by the consumer, through the artist's electronic device P2, and the artist may determine where the artwork of the photograph is better placed on the spatial information and transmit the artwork suggestion location information, which is information for suggesting the location of the artwork to be placed, to the server 10.

As an example, the artist may select the information about the desired location of the artwork described above as the artwork location information, or select location information in which a location different from the information about the desired location of the artwork is designated on the spatial information.

Here, as an example, in the artwork information acquisition step S115, the artwork information may be obtained from the electronic device P2 of the artist only up to the desired purchase date on the basis of the desired purchase period information.

More specifically, the server 10 may obtain the desired purchase period information (e.g., from today to the 7th of the next month) from the consumer in the consumer information acquisition step S111, and the artist may transmit the artwork information for the corresponding consumer to the server 10 only up to the desired purchase date (e.g., to the 7th of the next month), and may not transmit the artwork information for the corresponding consumer to the server 10 after the desired purchase date has passed.

The above may be implemented as an icon for transmitting the artwork information to the server 10 disappearing from a user interface screen provided by the server 10 to the electronic device P2 of the artist when the desired purchase date has passed.

Here, as an example, the artwork transaction method using the augmented reality may further include the augmented reality information generation step S116 in which the server 10 generates augmented reality information to be provided to the consumer in the artwork information provision step S119, which will be described below, on the basis of the obtained image and/or video of the artwork.

That is, when the server 10 obtains the image and/or video of the artwork from the electronic device P2 of the artist, the server 10 may process the image and/or video to generate the augmented reality information about the artwork.

Here, as an example, the artwork transaction method using the augmented reality may further include the alarm provision step S117 in which, when the server 10 obtains the artwork information, the server 10 provides an alarm indicating that the artwork information is obtained to the electronic device P1 of the consumer.

As an example, when the server 10 obtains the artwork information from the electronic device P2 of the artist, the server 10 may transmit an alarm indicating that the artwork information has been obtained from the artist to the electronic device P1 of the corresponding consumer.

As a result, the consumer may know the fact that the artwork information has been suggested to the consumer by the artist through the consumer's electronic device P1.

When the server 10 obtains the artwork information from each of several artists for the corresponding consumer, the server 10 may provide an alarm to the electronic device P1 of the consumer in the order in which the artwork information is obtained.

Here, as an example, the artwork transaction method using the augmented reality may further include the request information acquisition step S118 in which the server 10 obtains request information for requesting the artwork information from the electronic device P1 of the consumer.

In this case, an icon for requesting the artwork information may be displayed on the user interface screen provided by the server 10 to the electronic device P1 of the consumer, and the consumer may click the icon for requesting the artwork information on the consumer's electronic device P1 to transmit the request information to the server 10.

Here, as an example, the artwork transaction method using the augmented reality may further include the artwork information provision step S119 in which, when the server 10 obtains the request information from the electronic device P1 of the consumer, the server 10 provides the artwork information to the electronic device P1 of the consumer.

In this case, in the artwork information provision step S119, the augmented reality information about the artwork may be provided so that the artwork image is displayed in augmented reality in the space in which the artwork is to be placed in the electronic device P1 of the consumer.

That is, the server 10 does not provide the image and/or video of the artwork obtained from the electronic device P2 of the artist to the electronic device P1 of the consumer without change, and may provide the augmented reality information generated in the augmented reality information generation step S116 described above.

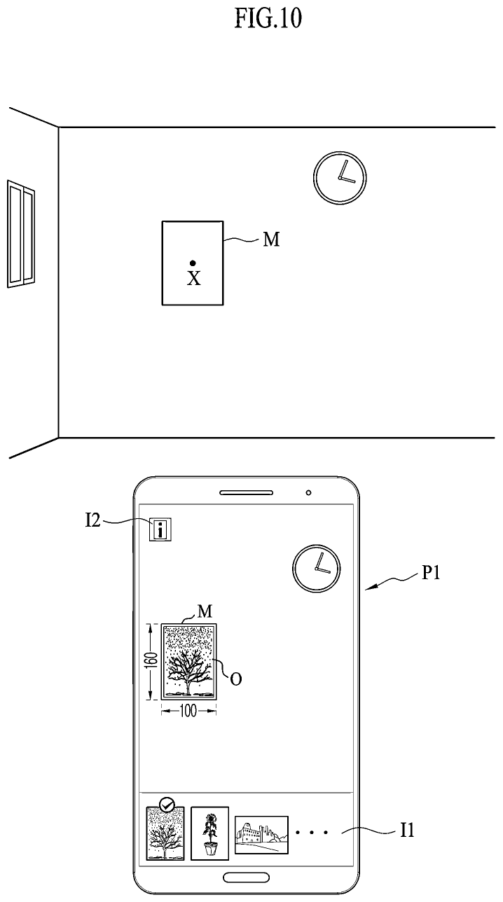

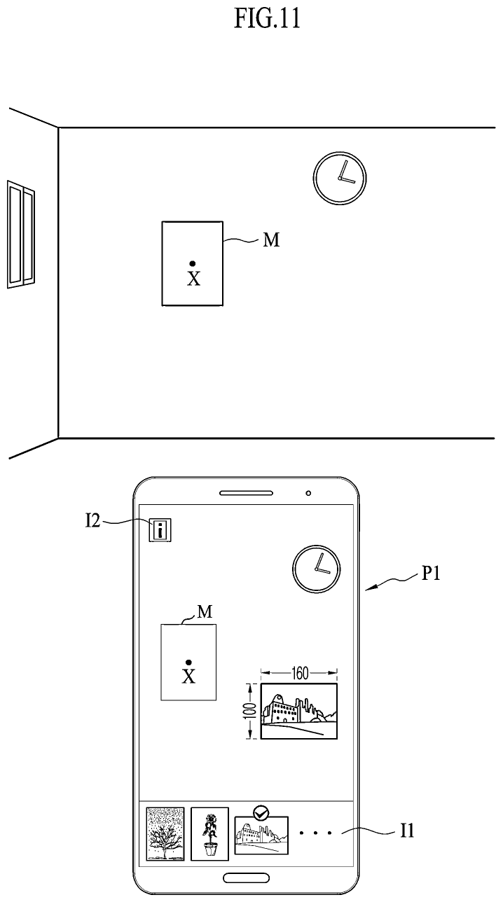

FIGS. 10 and 11 are views for describing examples of the augmented reality information displayed on the electronic device P1 of the consumer in the artwork information provision step S119, and as shown in FIG. 10, when the electronic device P1 of the consumer obtains the artwork information from the server 10, augmented reality information O about the artwork may be displayed on the electronic device P1 of the consumer.

As an example, the electronic device P1 of the consumer may display an image icon I1 for pieces of artwork provided by artists on an artwork icon, and when the consumer clicks the image icon for the artwork, and the augmented reality information about the corresponding artwork may be provided from the server 10 and the corresponding artwork may be displayed in augmented reality.

In this case, when the information about the desired location of the artwork and the artwork suggestion location information have the same location, the augmented reality information O may be displayed on a marker M or point X that is input by the consumer.

The server 10 may provide an information icon 12 as well as the augmented reality information to the electronic device P1 of the consumer, and when the consumer clicks the information icon 12, the server 10 may display the artwork information about the corresponding artist on the electronic device P1 of the consumer.

Meanwhile, as shown in FIG. 11, when the information about the desired location of the artwork and the artwork suggestion location information do not have the same location, that is, when the artist designates a different location from the desired location of the artwork desired by the consumer on the spatial information and inputs the information about the suggested location of the artwork, the server 10 may provide the augmented reality information to a location corresponding to the information about the suggested location of the artwork that is input by the artist.

In this case, the server 10 may calculate a distance and direction of the suggested location of the artwork that is input by the artist on the basis of the marker M or the point X to allow the augmented reality information to be displayed on the suggested location of the artwork that is input by the artist.

Therefore, the consumer can receive the suggestion for the artwork from the artist and also receive the suggestion for the placement location of the artwork.

Meanwhile, in the artwork information provision step S119, history information about a history of providing the artwork information for the same artwork may be further provided to the electronic device P1 of another consumer.

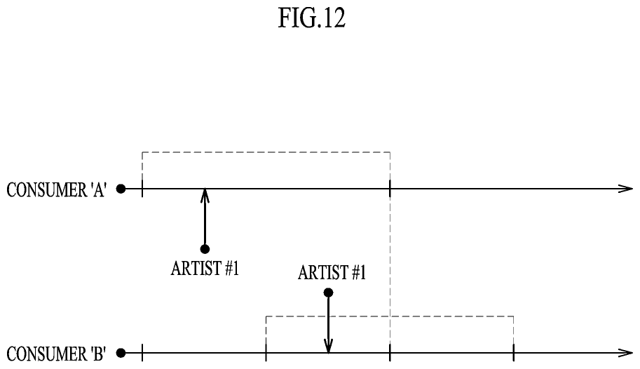

More specifically, as shown in FIG. 12, when an artist #1 transmits artwork information about any one piece of artwork for a consumer A to the server 10 and transmits the artwork information about the same artwork for a consumer B to the server 10, the server 10 may provide history information about an instance that the artist #1 provided the artwork information to the consumer B, to an electronic device P1 of the consumer A, and provide history information about an instance that the artist #1 provided the artwork information to the consumer A as well, to an electronic device P1 of the consumer B.

As a result, the consumer can recognize the fact that the corresponding artwork is likely to be sold not only to the consumer but also to another consumer.

Here, as an example, the artwork transaction method using the augmented reality may further include the purchasing intention information acquisition step S120 in which the server 10 obtains purchasing intention information, which is information indicating that the consumer intends to purchase the artwork, from the electronic device P1 of the consumer.

The consumer may select a specific piece of artwork from among several pieces of artwork through the consumer's electronic device P1 to transmit information about the consumer's intention to purchase to the server 10, and in this case, the consumer may readjust and transmit the desired purchase price to the server 10.

Here, in the purchasing intention information acquisition step S120, the consumer may transmit the purchasing intention information to the server 10 only up to the desired purchase date on the basis of the purchase period information input by the consumer, and after the desired purchase date has passed, the consumer cannot transmit the purchasing intention information to the server 10.

Here, as an example, the artwork transaction method using the augmented reality may further include the purchasing intention information provision step S121 in which, when the server 10 obtains the purchasing intention information, the server 10 provides the purchasing intention information to the electronic device P2 of the artist

Here, as an example, as shown in FIG. 12, in the case in which the artist #1 transmits the artwork information about any one piece of artwork for the consumer A to the server 10 and transmits the artwork information about the same piece of artwork for the consumer B to the server 10, when the consumer A transmits the purchasing intention information to the server 10, the server 10 may provide the purchasing intention information that is input by the consumer A and the purchase period information to the electronic device P1 of the consumer B as well.

As a result, the consumer B can determine whether to purchase the corresponding artwork in competition with the consumer A.

Meanwhile, the artwork transaction method using the augmented reality may further include the selling intention information acquisition step S122 in which the server 10 obtains selling intention information about whether the artist intends to sell the corresponding artwork, from the electronic device P2 of the artist.

When the selling intention information is information indicating that the artwork will be sold to the corresponding consumer, the server 10 may match to make a transaction between the consumer and the artist for the corresponding artwork, and store the consumer information, the artist information, and the artwork information that are related thereto.

Meanwhile, in the purchasing intention information acquisition step S120, when a plurality of consumers transmit their intention to purchase the same piece of artwork to the server 10 within the overlapping purchase period information, the server 10 may transmit the fact that the plurality of consumers intend to purchase the corresponding artwork to each of the electronic device P2 of the artist and the electronic devices P1 of the plurality of consumers, and provide a user interface for performing an auction to electronic devices P2 of the plurality of consumers and the corresponding artist.

Meanwhile, the artwork transaction method using the augmented reality may further include a similarity calculation step in which, when the server 10 obtains the image and/or video of the artwork in the artwork information acquisition step S115, the server 10 may store the image and/or video of the artwork, and furthermore, calculate a similarity by comparing the image and/or video of the artwork with an image and/or video of another piece of artwork previously obtained.

This is to prevent the artist from copying or from illegally copying the artwork of other artists to sell the artwork to consumers.

Therefore, when the server 10 obtains the image and/or video of the artwork from the specific electronic device P2 of the artist in the artwork information acquisition step S115, the server 10 may extract the artwork image, the artwork information, and the history information having a similarity greater than or equal to a preset similarity in the similarity calculation step, and these pieces of information may be provided to the electronic device P1 of the consumer in the artwork information provision step S119.

It is obvious that the calculation of the similarity between any one artwork image and another artwork image described above can be implemented by a known image similarity determination technique.

Hereinafter, an artwork transaction system 10 using augmented reality will be described with reference to FIG. 6.

As an example, the artwork transaction system 10 using the augmented reality may be the server for implementing the artwork transaction method using the augmented reality described above.

As an example, the artwork transaction system 10 using the augmented reality may include a communication unit 200 that transmits or receives information/data required to implement the artwork transaction method using the augmented reality to or from an electronic device P1 of a consumer and an electronic device P2 of an artist.

For example, the communication unit 200 may transmit or receive the information required to implement the artwork transaction method using the augmented reality, such as the consumer information, the artist information, the artwork information, and the like, to or from the electronic device P1 of the consumer and the electronic device P2 of the artist.

Further, as an example, the artwork transaction system 10 using the augmented reality may further include a memory unit 300 in which the information/data required to implement the artwork transaction method using the augmented reality transmitted to or received from the electronic device P1 of the consumer and the electronic device P2 of the artist is stored.

For example, in the memory unit 300, the information/data required to implement the artwork transaction method using the augmented reality, such as the consumer information, the artist information, the artwork information, the history information, and the like may be stored.

Here, as an example, the artwork transaction system 10 using the augmented reality may further include a calculation unit 100 that computes, calculates, and controls the information/data required to implement the artwork transaction method using the augmented reality.

For example, the calculation unit 100 may compare the consumer information with the artist information to extract artists who will provide the consumer information, generate augmented reality information, and compare artwork images with each other to calculate a similarity.

As an example, the artwork transaction system 10 using the augmented reality may further include an input unit 400 that receives information/data/arithmetic expressions of a predetermined format required to implement the artwork transaction method using the augmented reality from a manager.

As an example, as an example, the artwork transaction system 10 using the augmented reality may further include a display unit 500 for displaying the information/data of the predetermined format required to implement the artwork transaction method using the augmented reality to the manager.

Although the configuration and features of the present invention have been described with reference to embodiments of the present invention, the present invention is not limited thereto. In addition, those skilled in the art may easily change and modify the embodiments within the spirit and scope of the present invention and it will be clear that such changes or modifications fall within the scope of the appended claims.

1. A method of providing information about an artist to a user using a mural, comprising:
an artist registration step in which a server obtains artist information including a mural of a predetermined format from an electronic device of an artist to register the artist information about the artist; and
a user use step in which the server obtains request information including a mural of a predetermined format from an electronic device of a user and provides, to the electronic device of the user, artist information about an artist, from among a plurality of registered artists, that satisfies a predetermined matching condition on the basis of the request information,
wherein the predetermined matching condition is a condition in which a similarity obtained by comparing an image of the mural included in the request information with an image of each mural included in artist information about the plurality of registered artists satisfies a preset similarity or higher.

2. The method of claim 1, wherein, in the artist registration step, the server further obtains artist location information from the electronic device of the artist,
in the user use step, the server further obtains user location information from the electronic device of the user, and
the predetermined matching condition is a condition in which a similarity obtained by comparing an image of the mural included in the request information and the user location information with an image of each mural included in the artist information about the plurality of registered artists and the artist location information satisfies a preset similarity or higher.

3. The method of claim 2, wherein the predetermined matching condition is a condition in which the artist information about the plurality of registered artists, in which a similarity between the user location information and the artist location information satisfies a preset similarity or higher, is primarily extracted and a similarity obtained by secondarily comparing an image of each mural included in the extracted artist information about the plurality of artists with an image of the mural included in the request information satisfies a preset similarity or higher.

4. The method of claim 3, wherein the artist registration step includes:
a mural registration step in which the server obtains the mural from the electronic device of the artist to register the mural as a marker;
an artist information acquisition step in which the server obtains the artist information including contact information and artwork information of the artist from the electronic device of the artist; and
an artist information storage step in which the server matches and stores the artist information with the mural.

5. The method of claim 4, wherein, in the mural registration step,
the server obtains the mural photographed at several angles and the artist location information from the electronic device of the artist to primarily generate an experimental marker,
the server reobtains the mural photographed at several angles from the electronic device of the artist to secondarily determine whether the experimental marker functions properly, and
when it is determined that the experimental marker functions properly, the server registers the experimental marker as the marker.

6. The method of claim 5, wherein, in the mural registration step,
when the server obtains the mural photographed at several angles from the electronic device of the artist, the server determines whether a similarity between an image of the photographed mural and an image of a mural of another registered artist is greater than or equal to a preset similarity.

7. The method of claim 3, wherein, in the user use step,
the server obtains and stores user information including the user location information and the user's age or age group from the electronic device of the user.

8. A system for providing information about an artist to a user using a mural, the system is configured to:
obtain artist information including a mural of a predetermined format from an electronic device of an artist to register the artist information about the artist; and
obtain request information including a mural of a predetermined format from an electronic device of a user and provide, to the electronic device of the user, artist information about an artist, from among a plurality of registered artists, that satisfies a predetermined matching condition on the basis of the request information,
wherein the predetermined matching condition is a condition in which a similarity obtained by comparing an image of the mural included in the request information with an image of each mural included in the artist information about the plurality of registered artists satisfies a preset similarity or higher.

9. The system of claim 8, wherein the system is configured to:
further obtain artist location information from the electronic device of the artist; and
further obtain user location information from the electronic device of the user,
wherein the predetermined matching condition is a condition in which a similarity obtained by comparing an image of the murals included in the request information and the user location information with an image of each mural included in the artist information about the plurality of registered artists and the artist location information satisfies a preset similarity or higher.

10. The system of claim 9, wherein the predetermined matching condition is a condition in which the artist information about the plurality of registered artists, in which a similarity between the user location information and the artist location information satisfies a preset similarity or higher, is primarily extracted and a similarity obtained by secondarily comparing an image of the mural included in the extracted artist information about the plurality of artists with an image of the mural included in the request information satisfies a preset similarity or higher.

11. The system of claim 10, wherein the system is configured to:
obtain the mural from the electronic device of the artist to register the mural as a marker;
obtain the artist information including contact information and artwork information of the artist from the electronic device of the artist; and
match and store the artist information with the mural.

12. The system of claim 11, wherein the system is configured to:
obtain the mural photographed at several angles and the artist location information from the electronic device of the artist to primarily generate an experimental marker;
reobtain the mural photographed at several angles from the electronic device of the artist to secondarily determine whether the experimental marker functions properly; and
when it is determined that the experimental marker functions properly, register the experimental marker as the marker.

13. The system of claim 12, wherein, when the system obtains the mural photographed at several angles from the electronic device of the artist, the system determines whether a similarity between an image of the photographed mural and an image of a mural of another registered artist is greater than or equal to a preset similarity.

14. The system of claim 11, wherein the system obtains and stores user information including the user location information and the user's age or age group from the electronic device of the user.
